(19) United States
(12) Patent Application Publication
(10) Pub. No.: US 2022/0056927 A1
(43) Pub. Date: Feb. 24, 2022

(54) ELECTRIC HYDRAULIC ACTUATOR

(71) Applicant: DONG JIN ELECTRIC & PRECISION CO., LTD., Gimhae-si (KR)

(72) Inventors: Ho Kil LEE, Busan (KR); Jae Serk PARK, Gimhae-si, Gyeongsangnam-do (KR); Hee Bong JUNG, Busan (KR); Min Chan KIM, Busan (KR)

(73) Assignee: DONG JIN ELECTRIC & PRECISION CO., LTD.

(21) Appl. No.: 17/034,208

(22) Filed: Sep. 28, 2020

(30) Foreign Application Priority Data
Aug. 19, 2020 (KR) 10-2020-0103865

(51) Int. Cl. F15B 13/10; F15B 11/10; F15B 13/02; F15B 13/04; F15B 15/14

(52) U.S. Cl. CPC F15B 13/10; F15B 11/10; F15B 2215/30; F15B 13/0401; F15B 15/1457; F15B 13/027

(57) ABSTRACT

Disclosed is an electric hydraulic actuator including a hydraulic cylinder and the hydraulic power generator. The hydraulic cylinder includes a hollow rod that is connected to a piston and is linearly movable to protrude outward or to retract. The hydraulic power generator includes a motor, a fluid tank, and a gear pump and a pilot check valve disposed in a pump housing. The cylinder housing and the pump housing are directly coupled to each other. The cylinder housing includes a first port through which the working fluid is transferred to a first side of the piston and a second port connected to a return pipe that is provided in the hollow rod. The pump housing includes a third port that is configured to communicate with the first port and a fourth port that is configured to communicate with the second port.

### REFERENCE TO RELATED APPLICATIONS

This application claims the priority benefit of Korean Patent Application No. 10-2020-0103865 filed on Aug. 19, 2020, the entire contents of which are incorporated herein by reference.

### FIELD OF THE INVENTION

The invention relates to an electric hydraulic actuator that operates without external supply of a working fluid.

### BACKGROUND OF THE INVENTION

A hydraulic actuator that is operated through control of a working fluid is connected to a hydraulic power generator composed of a hydraulic pump, a switching valve, and the like when the actuator is operated.

That is, various operating tools (i.e., hydraulic actuators) driven by hydraulic pressure are connected to a hydraulic power generator via hydraulic piping, and a control valve for opening and closing supply and recovery paths of a working fluid is used to control the operation of the hydraulic actuators.

Such existing hydraulic actuators using conventional techniques have a problem in that a coupling structure between each of the components including a hydraulic power generator such as a hydraulic pump, a fluid tank, and a control valve is complicated, and thus maintenance work thereof is difficult.

In addition, when there is external physical shock or overload occurs during the operation of the hydraulic actuator, hydraulic piping may be damaged, resulting in oil leakage which can lead to environmental contamination.

Therefore, to address the problem described above, hydraulic actuators in which a hydraulic cylinder and a hydraulic power generator are integrated have been developed.

One example of such a conventional integrated hydraulic actuator is illustrated in FIG. 1.

Referring to FIG. 1, a hydraulic actuator 1 according to a conventional art includes a hydraulic cylinder 2 and a hydraulic power generator 3 that are integrally formed and are operated without external supply of a working fluid.

To this end, the hydraulic cylinder 2 is configured such that a piston 23 connected to a reciprocating rod 22 received in a cylinder body 21 slides along an axial direction, and the piston 23 functions as a partition that divides the internal space of the cylinder body 21 into a piston-side chamber 2a and a rod-side chamber 2b.

The direction of movement of the piston 23 is determined according to the amount of a working fluid supplied to each of the piston-side chamber 2a and the rod-side chamber 2b, and the working fluid is supplied according to the operation of the hydraulic power generator 3.

The hydraulic power generator 3 includes an electric motor 31, a hydraulic pump 32 driven by the electric motor 31, a rear case 33 integrally formed with the hydraulic pump 32, and a fluid tank 35 connected to the rear case 33 via a valve block 34.

In addition, the electric motor 31, the hydraulic pump 32, the rear case 33, the valve block 34, and the fluid tank 35 are arranged side by side along a fastening member 39. In this state, the hydraulic cylinder 2 is disposed under and in parallel with the connecting member 39. The hydraulic actuator 1 in which an oil supply function and a cylinder driving mechanism are integrated is configured as described above.

The hydraulic pump 32 has two pump ports 32a and 32b that are symmetric to each other and can rotate in a forward direction and a reverse direction to control a direction in which the working fluid is transferred.

The valve block 34 is disposed between the rear case 33 and the fluid tank 35. The valve block 34 has fluid channels 38a and 38b and two pilot check valves 36a and 36b installed in the respective fluid channels 38a and 38b.

The working fluid contained in the fluid tank 35 is supplied to the piston-side chamber 2a and the rod-side chamber 2b or the working fluid in the hydraulic cylinder 2 is returned to the fluid tank 35, according to the operation of the hydraulic pump 32. To this end, an intermediate pipe 33c is connected to the piston-side chamber 2a and an intermediate pipe 33d is connected to the rod-side chamber 2b.

That is, as illustrated in FIG. 1, the intermediate pipes 33c and 33d are connected to the ends of the cylinder pump 32, respectively. Through the intermediate pipes 33c and 33d, the working fluid for moving the piston 23 can be supplied to or discharged from the hydraulic cylinder. With this configuration, the hydraulic actuator operates according to the shortage or excess of the working fluid in each of the chambers 2a and 2b when the reciprocating rod 22 moves.

However, in the related art described above, the two separate intermediate pipes 33c and 33d are respectively connected to the ends of the hydraulic cylinder body 21 to form fluid supply and recovery paths. Therefore, there is a problem in that the length of the fluid channel is long and complicated. In addition, since the intermediate pipes 33c and 33d are disposed outside the cylinder body 21, there is a risk of damage to the intermediate pipes 33c and 33d.

The conventional hydraulic actuator described above is disclosed in Japanese Patent No. 3866205 titled “Hydraulic Drive Device”.

### SUMMARY OF THE INVENTION

An objective of the present invention is to provide an electric hydraulic actuator in which a hydraulic cylinder and a hydraulic power generator are combined in a manner that a cylinder housing and a pump housing in which a gear pump and a pilot check valve are accommodated are directly coupled to each other without using an additional connection member.

Another objective of the present invention is to provide an electric hydraulic actuator having a simplified structure that is obtained by modifying supply and recovery paths of a working fluid in a manner to be adaptable to the coupling structure between the cylinder housing and the pump housing.

According to one embodiment of the present invention, there is provided an electric hydraulic actuator including: a hydraulic cylinder including a hollow rod that is connected to a piston and is linearly movable to protrude outward or to retract when a working fluid is supplied to or discharged from a cylinder housing; and a hydraulic power generator including a motor, a fluid tank, and a gear pump and a pilot check valve disposed in a pump housing, the hydraulic power generator converting a rotational force of the motor into a hydraulic pressure and transferring the hydraulic pressure to the hydraulic cylinder. The cylinder housing and the pump housing are directly coupled to each other. The cylinder housing includes a first port through which the working fluid is transferred to a first side of the piston so that the hollow rod is driven outward to protrude an increased distance from a leading end of the cylinder tube and a second port connected to a return pipe that is provided in the hollow rod and through which the working fluid is discharged from the hollow rod. The pump housing includes a third port that is configured to communicate with the first port and through which the working fluid extracted from the fluid tank is supplied to the hydraulic cylinder due to a negative pressure generated by rotation of the motor and a fourth port that is configured to communicate with the second port and through which the working fluid discharged from the return pipe is transferred to the gear pump.

According to another embodiment of the present invention, there is provided an electric hydraulic actuator including: a motor providing a rotational force; a pump housing provided with a gear pump that converts the rotational force of the motor to a hydraulic pressure and thus forces a fluid to move and with a pilot check valve that changes a fluid flow path using the hydraulic pressure; a fluid tank disposed between the motor and the pump housing and providing a fluid storage space; a coupler extending through the fluid tank and connecting a rotary shaft of the motor and the gear pump to each other; a cylinder tube; a hollow rod disposed in the cylinder tube and connected to a piston so that a length of a portion of the cylinder tube exposed outside the cylinder tube varies according to a fluid supply path determined by operation of the gear pump; a cylinder housing coupled to one end of the cylinder tube and to the pump housing, the cylinder housing including two ports for transferring the fluid; and a return pipe having a first end coupled to the cylinder housing and a second end positioned within the hollow rod, thereby forming a flow path of the fluid between an internal space of the hollow rod and an internal space of the cylinder housing. The two ports of the cylinder housing include a first port forming a flow path of the fluid supplied to a first side of the piston and a second port forming a flow path of the fluid returned to the return pipe. The pump housing includes a third port corresponding to the first port and functioning to transfer the fluid to the gear pump and a fourth port corresponding to the second port and functioning to transfer the fluid to the gear pump.

Two or more volume supplementary members having an air cell structure may be disposed in the fluid tank to fill an empty portion of the fluid tank when a fluid shortage occurs in the fluid tank when the fluid is returned to the fluid tank.

The electric hydraulic actuator may further include a guide pipe disposed between the volume supplementary member and a coupler.

The third port and the fourth port may be connected to each other via a fifth port and a manual switching two-way check valve. The manual switching two-way check valve may have a relief function of simultaneously relieving a hydraulic pressure applied to the third port and a hydraulic pressure applied to the fourth port by changing a coupling position of a body thereof. The manual switching two-way check valve may include a third check valve and a fourth check valve that are disposed in the body and arranged to face each other with one spring interposed therebetween. The manual switching two-way check valve may have a two-way release function in which when a fluid pressure higher than a predetermined pressure is detected at one of the third and fourth ports due to an elastic force of the spring, one of the third and fourth check valves, which is in contact with the one port of the third and fourth ports, is opened so that an overpressure is released.

An internal space of the cylinder tube may be partitioned into a piston-side chamber defined between the piston and the cylinder housing and a rod-side chamber defined between the piston and a cylinder cap covering a second end of the cylinder tube. A rod-side hole may be formed in a side portion of the hollow rod to transfer the fluid contained in the rod-side chamber into the hollow rod. A return pipe main hole may be formed at an end of the return pipe to form an inflow path extending from the rod-side hole to an internal space of the hollow rod.

At least one return pipe-side hole may be formed in a side portion of the return pipe in the vicinity of the return pipe main hole.

The rod-side hole may be formed in the vicinity of the piston.

In the hydraulic actuator according to the present invention, the hydraulic power generator and the hydraulic cylinder are combined in a manner that the cylinder housing which is coupled to the cylinder tube and the pump housing which accommodates the gear pump and the pilot check valve are directly coupled to each other without using an additional connection member. That is, the hydraulic power generator and the hydraulic cylinder can be coupled to each outer without using an additional connection member.

According to the present invention, the hydraulic power generator is coupled to one end of the hydraulic cylinder. With this coupling structure, the fluid channel is modified to be different from that of an existing hydraulic actuator, thereby effectively adjusting the moving distance of the cylinder tube. Therefore, the electric hydraulic actuator can be miniaturized.

In the hydraulic actuator according to the present invention, each of the cylinder housing and the pump housing is provided with multiple ports for supply and recovery of a working fluid. The fluid introduced into or discharged from the hollow rod moves through the return pipe communicating with the cylinder housing. Therefore, the flow of the fluid is confined in the cylinder housing.

According to the present invention, the motor and the gear pump are coupled to each other via the coupler extending through the fluid tank. Therefore, the pump housing and the cylinder housing can be directly coupled to each other.

The inside of the fluid tank is provided with multiple volume supplementary members surrounding the coupler. Therefore, the shortage of the working fluid, which is attributable to the return of the working fluid, can be supplemented. Since the multiple volume supplementary members are disposed in the fluid tank, although one of the volume supplementary members is damaged, the function of the volume supplementary members can be still performed by the other normal volume supplementary members.

According to the present invention, since the guide pipe having a bearing inside thereof is provided between the coupler and the volume supplementary member, it is possible to prevent the volume supplementary member from being worn by the coupler and to ensure stable rotation of the coupler.

### BRIEF DESCRIPTION OF THE DRAWINGS

The above and other objectives, features, and other advantages of the present invention will be more clearly understood from the following detailed description taken in conjunction with the accompanying drawings, in which:

FIG. 1 is a view illustrating a hydraulic actuator according to a related art;

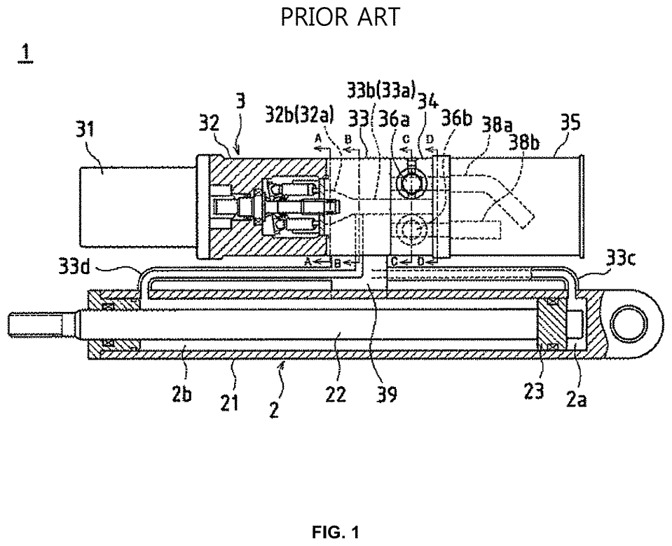

FIG. 2 is a view illustrating an electric hydraulic actuator according to one embodiment of the present invention;

FIG. 3 is an exploded perspective view of a coupling structure between main configurations of the present invention;

FIG. 4 is a cross-sectional view illustrating an internal coupling structure of the present invention;

FIGS. 5A and 5B are views illustrating a coupling structure between a pump housing and a cylinder housing;

FIGS. 6A and 6B are cross-sectional views respectively taken along line B-B′ and line C-C′ of FIG. 5;

FIG. 7 is a view illustrating operation of a gear pump that is one of the main configurations of the present invention;

FIGS. 8A and 8B are views respectively illustrating a working fluid supply path and a working fluid return path formed in the pump housing and the cylinder housing;

FIG. 9 is a view illustrating a working fluid supply path that communicates with the structure of FIG. 8A and along which a working fluid moves to drive a rod outward in a cylinder; and

FIG. 10 is a view illustrating a working fluid recovery path along which the working fluid is returned in a state in which the rod is driven out.

### DETAILED DESCRIPTION OF THE INVENTION

Hereinafter, exemplary embodiments of the invention will be described in detail with reference to the accompanying drawings. When components are given reference numerals in the drawings, the same components are given the same reference numerals even if they are shown in different drawings. Further, in the following description of embodiments of the present invention, when detailed descriptions of well-known configurations or functions are determined as interfering with understanding of the embodiments of the present invention, they are not described in detail. It will be further understood that the terms used herein are terms selected in consideration of functions in the present invention and may vary according to the intention of users or operators or according to custom, so it is desirable that the definitions of the terms be understood on the basis of the contents in the specification that describes the present invention.

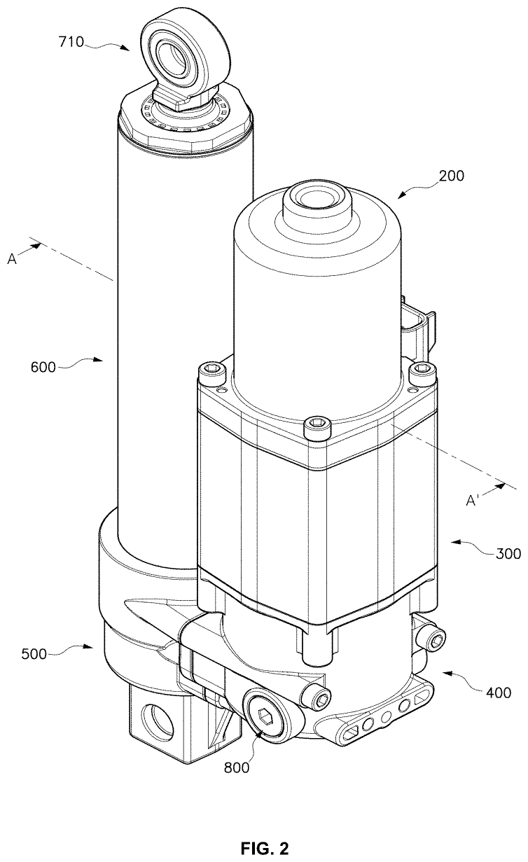

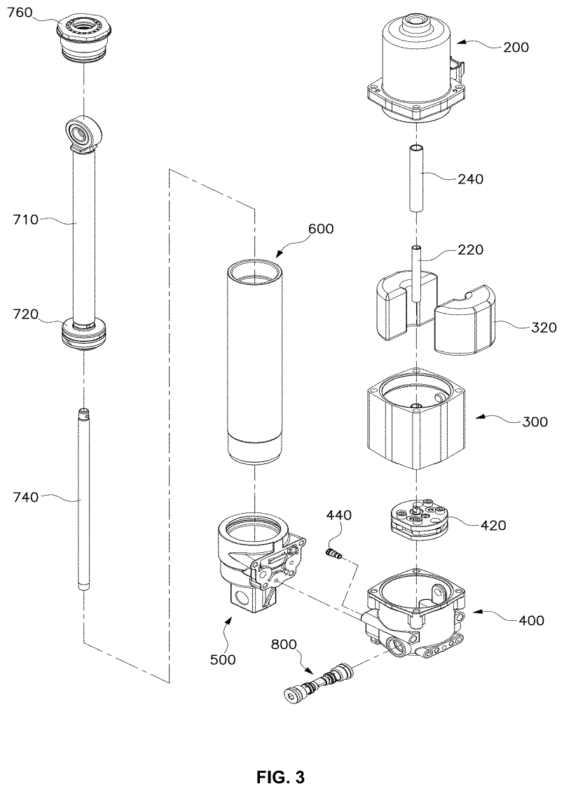

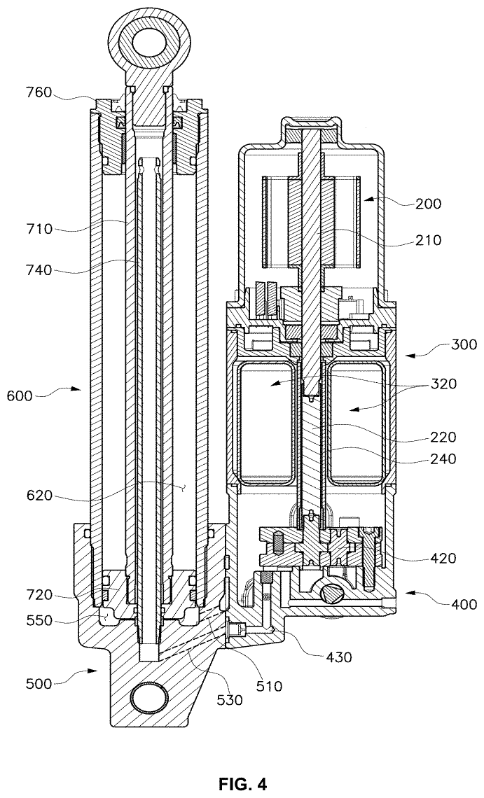

FIG. 2 is a view illustrating an electric hydraulic actuator according to one embodiment of the present invention, FIG. 3 is an exploded perspective view of a coupling structure between main configurations of the present invention, and FIG. 4 is a cross-sectional view illustrating an internal structure of the present invention.

Referring to the accompanying drawings, an electric hydraulic actuator according to one embodiment of the present invention includes a hydraulic cylinder and a hydraulic power generator that are directly coupled to each other so that a working fluid circulates through a closed loop path. Therefore, the electric hydraulic actuator independently operates without connection to external piping.

Specifically, the hydraulic cylinder includes a cylinder tube 600, a cylinder housing 500 coupled to a first end of the cylinder tube 600 in a screwed manner, and a cylinder cap 760 coupled to a second end of the cylinder tube 600 in a screwed manner. A hollow rod 710 longitudinally extends through the cylinder tube 600 and a leading end portion of the hollow rod 710 protrudes from the second end of the cylinder tube 600 through the cylinder cap 760. The length of the hollow rod 710 exposed outside the cylinder tube 600 is adjustable.

The internal space of the cylinder tube 600 is sealed with a sealing means such as an O-ring so that the working fluid contained in the cylinder tube 600 cannot leak when the cylinder cap 760 and the cylinder housing 500 are assembled with the cylinder tube 600.

A piston 720 connected to the hollow rod 710 slides in the cylinder tube 600 and partitions the internal space of the cylinder tube 600 into a piston-side chamber 550 and a rod-side chamber 620.

The piston 720 has a diameter corresponding to the inner diameter of the cylinder tube 600 and slides according to the direction of flow of the working fluid, thereby changing the volume of each of the piston-side chamber 550 and the rod-side chamber 620.

A return pipe 740 is disposed in the hollow rod 710.

A first end of the return pipe 740 is connected to the cylinder housing 500 and a second end of the return pipe 740 is positioned in the hollow rod 710. That is, the internal space of the hollow rod 710 communicates with the internal space of the cylinder housing 500 through the return pipe 740. The return pipe 740 provides a partial fluid supply/recovery path.

The fluid flow path for changing the distance of the linear movement of the hollow rod 710 will be described in greater detail below with reference to the accompanying drawings.

The hydraulic power generator converts the rotational force of a motor 200 into a hydraulic pressure, adjusts the hydraulic pressure, and transfers the adjusted hydraulic pressure to the hydraulic cylinder. To this end, the hydraulic power generator includes the motor 200, a fluid tank 300, a gear pump 420, a pilot check valve 800, and a pump housing 400.

The rotational force of the motor 200 is transferred to the hydraulic cylinder through the fluid tank 300 by a coupler 220 connected to the gear pump 420.

The motor 200 is a direct current (DC) reversible motor and includes an oil seal member and a circuit breaker.

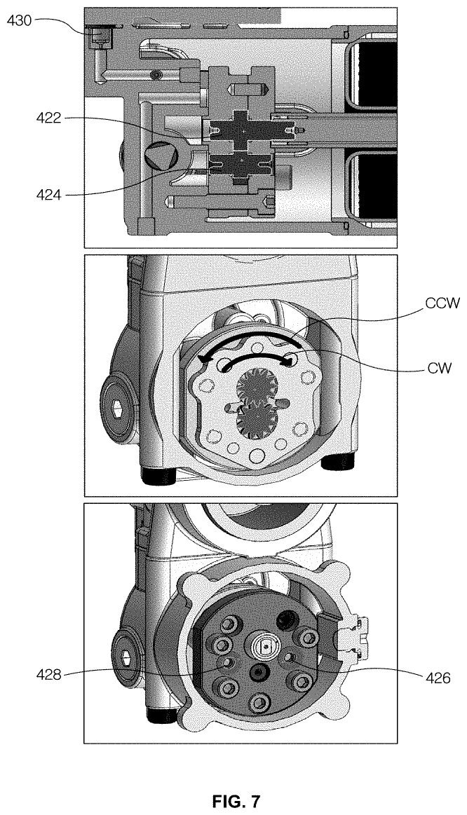

Typically, the coupler 220 has a cylindrical shape. A first end of the coupler 220 is engaged with a rotary shaft of the motor 200, and a second end of the coupler 220 is engaged with a driving gear 422 (see FIG. 7) that constitutes the gear pump 420.

The coupler 220 extends through the oil tank 300 and connects the gear pump 420 and the motor 200 to each other. Therefore, the length of the coupler 220 is set to be equal to or greater than the length of the fluid tank 300.

The outer surface of the coupler 220 is surrounded by a volume supplementary member 320.

The volume supplementary member 320 is a member having a plurality of air cells and configured to surround the coupler 220. In one embodiment of the present invention, the coupler 220 is surrounded by two volume supplementary members 320.

In addition, the volume supplementary members 320 functions to variably fill an empty portion of the fluid tank 300 according to the amount of fluid being returned to the fluid tank 300.

Specifically, when the hollow rod 710 is linearly moved to protrude more from the cylinder tube, the fluid is transported to the piston-side chamber 550 by the gear pump 420. To this end, the piston-side chamber 550 communicates with the gear pump 420 via a first port 510 formed in the cylinder housing 500 and a third port 410 formed in the pump housing 400.

When the fluid contained in the fluid tank 300 is supplied to the piston-side chamber 550 in a manner described above, the fluid contained in the rod-side chamber 620 is supplied to the gear pump 420 and then to the fluid tank 300 through the hollow rod 710, the return pipe 740, and a second port 530 formed in the cylinder housing 500, and a fourth port 430 formed in the pump housing 400.

However, due to a volume difference between the fluid supplied to the piston-side chamber 550 and the fluid returned from the rod-side chamber 620 to the fluid tank 300, cavitation occurs in the fluid tank 300. This causes noise, vibration, poor fluid circulation, and hydraulic pressure drop.

For this reason, according to the present invention, the multiple volume supplementary members 320 are provided in the fluid tank 300. The volume supplementary members 320 fill an empty portion of the fluid tank 300 when the volume of fluid returned to the fluid tank 300 is smaller than the volume of the fluid supplied to the piston-side chamber. Therefore, cavitation is prevented, resulting in stable operation of the hydraulic actuator.

In addition, a guide pipe 240 is provided between the volume supplementary member 320 and the coupler 220.

The guide pipe 240 prevents wear of the volume supplementary member 320 while not interfering with rotation of the motor 200 when the volume supplementary member 320 is compressed.

To this end, the guide pipe 240 is installed to surround the coupler 220, and a bearing is provided on an inner surface of the guide pipe 240 to enable the coupler 220 from stably rotating in the guide pipe 24.

The gear pump 420 includes a driving gear 422 (see FIG. 7), a driven gear 424 (see FIG. 7), and two check valves.

The gear pump 420 controls a check valve that is opened when the hollow rod 710 is driven outward and a check valve that is opened when the hollow rod 710 is retracted, thereby switching the supply path of the fluid according to the direction of rotation of the driving gear 422 (see FIG. 7) in conjunction with a pilot check valve 800 which will be described below.

The pump housing 400 accommodates the gear pump 420 and is engaged with the pilot check valve 800. The pump housing 400 provides a fluid flow path that passes through the gear pump 420 and the pilot check valve 800.

In addition, the fluid flow path formed in the pump housing 400 communicates with the fluid flow path formed in the cylinder housing 500 to form a closed-loop circulation path for driving and retraction of the hollow rod 710.

That is, the electric hydraulic actuator according to the present invention is configured such that the cylinder housing 600 for fixing the hydraulic cylinder is directly coupled to the pump housing 400 for accommodating the gear pump 420 and the pilot check valve 800, thereby forming a closed-loop circulation path.

The coupling positions of the motor 200, the fluid tank 300, and the pump housing 400 are determined to form such a closed-loop circulation path. In addition, the return pipe 740 is disposed inside the hollow rod 710 to form the fluid flow path. Hereinafter, the structural features of the present invention will be described in more detail with reference to the accompanying drawings.

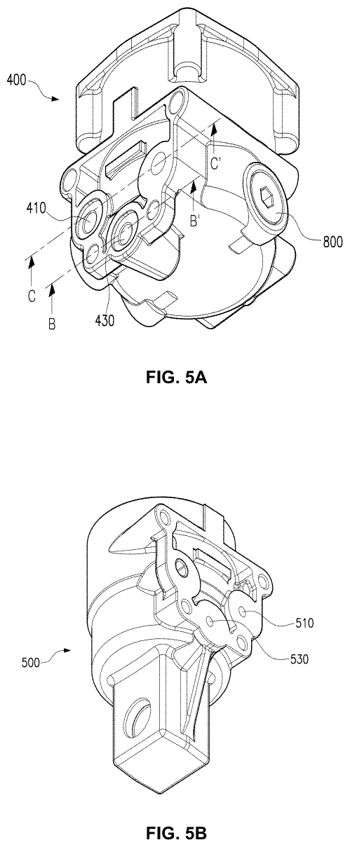

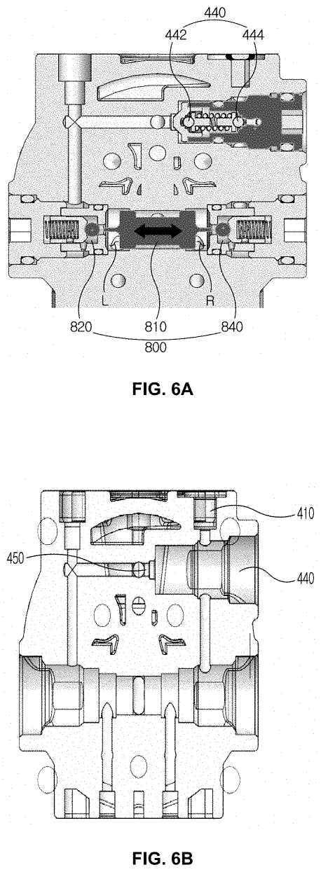

FIGS. 5A and 5B are views illustrating the coupling structure between the pump housing and the cylinder housing that are the main configurations of the present invention, and FIGS. 6A and 6B are cross-sectional views respectively taken along line B-B′ and C-C′ of FIG. 5.

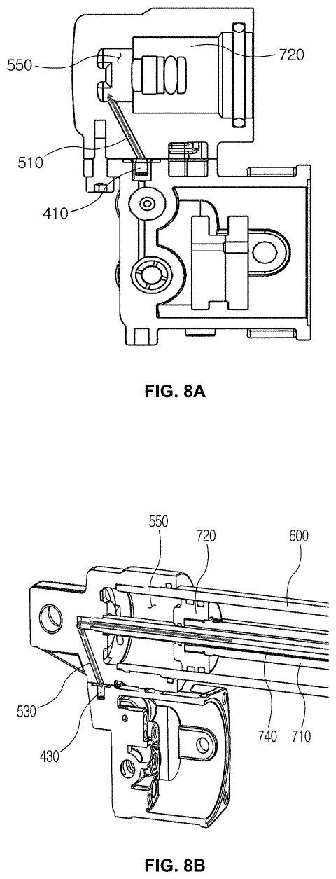

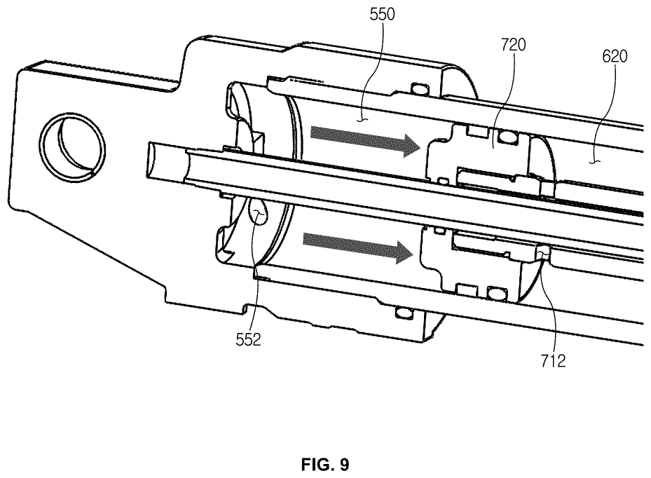

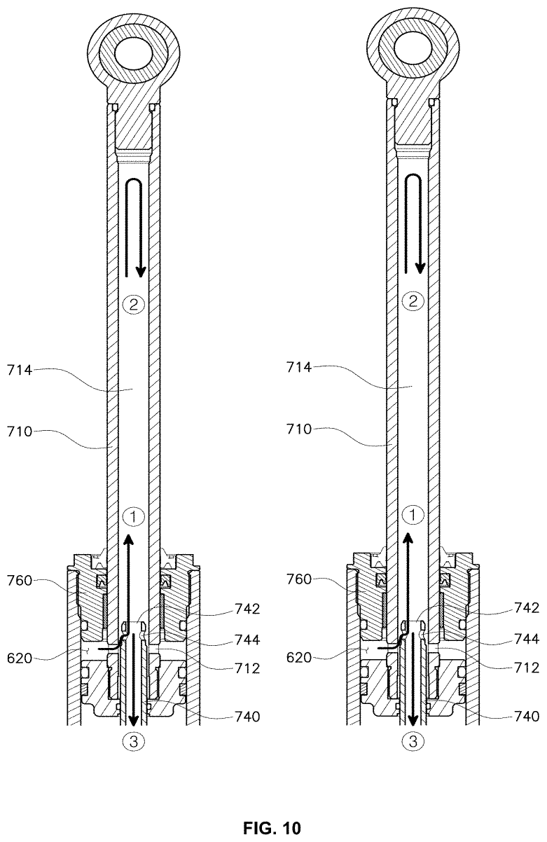

FIG. 7 is a diagram illustrating the operation mechanism of the gear pump which is one of the main configurations of the present invention. FIGS. 8A and 8B are diagrams respectively illustrating a working fluid supply path and a working fluid recovery path formed in the pump housing and the cylinder housing. FIG. 9 is a cross-sectional view illustrating a working fluid supply path that communicates with the working fluid supply path illustrated in FIG. 8A in a case where the hollow rod is driven outward so that a portion of the hollow rod exposed outside the cylinder tube is increased. FIG. 10 is a diagram illustrating a fluid flow path in a case where the working fluid is returned after the hollow rod is driven outward.

As illustrated in the figures, the cylinder housing 500 has a first port 510 communicating with the piston-side chamber 550 and a second port 530 communicating with the rod-side chamber 620, and the pump housing 400 has a third port 410 communicating with a fifth check valve 426 formed in the gear pump 420 and a fourth port 430 communicating with a sixth check valve 428.

When the cylinder housing 500 and the pump housing 400 are coupled to each other, the first port 510 and the third port 410 are positioned to correspond to each other, and the second port 530 and the fourth port 430 are positioned to correspond to each other, thereby forming a fluid flow path provided between the fluid tank 300 and the piston-side chamber 550 and a fluid flow path provided between the fluid tank 300 and the rod-side chamber 620.

Each of the fluid flow paths is opened or closed according to the direction of rotation of the gear pump 420 and the operation of the pilot check valve 800 that is opened or closed according to the direction of rotation of the gear pump 420.

The gear pump 420 is structured to open one of the two check valves according to the direction of rotation of the driving gear 422 thereof. Hereinafter, the fluid flow path formed when the driving gear 422 rotates in a clockwise direction CW will be described.

The inside of the pump housing 400 is provided with the pilot check valve 800 and a fluid suction passages connected to fifth and sixth check valves 426 and 428. The introduced fluid moves a spool 810 constituting the pilot check valve 800, thereby changing the fluid flow path.

Specifically, the pilot check valve 800 includes the spool 810 and first and second check valves 820 and 840 which are accommodated in an accommodation space of the pump housing 400.

The spool 810 is positioned in the center of the accommodation space. The spool 810 is configured such that first and second ends thereof press the first and second check valves 820 and 840, respectively so that the first and second check valves 802 and 840 can be opened. In the present embodiment, each of the first and second ends of the spool 810 is provided with a protrusion that presses a ball provided an inlet portion of a corresponding one of the first and second check valves 820 and 840.

The first check valve 820 and the second check valve 840 are installed at left and right sides of the spool 810, respectively. The first check valve 820 and the second check valve 840 are arranged to face each other with the spool 810 interposed therebetween. The first and second check valves 820 and 840 are opened when the pressing force generated by the spool 810 is maintained. When the pressing force of the spool 810 is released, the first and second check valves 820 and 840 are closed due to the elastic force of an elastic spring that supports the balls.

In addition, a left chamber L is defined between the left end of the spool 810 and the first check valve 820 and a right chamber R is defined between the right end of the spool 810 and the second check valve 840.

The left chamber L and the right chamber R are spaces in which a negative pressure is generated by the gear pump 420 or in which the hydraulic pressure is generated by the oil supply. The left chamber L and the right chamber R are connected to the fifth check valve 426 and the sixth check valve 428 so that the fluid can be transferred to the left and right chambers L and R from the fluid tank 300.

Specifically, when the driving gear 422 rotates in the clockwise direction CW, the fluid is transferred to the left chamber L through the sixth check valve 428 and then to the right chamber R.

When the fluid is transferred, a negative pressure is created in the left chamber L and a hydraulic pressure is created in the right chamber R to open the second check valve 840. The hydraulic pressure moves the spool 810 to the left, and the protrusion protruding from the left end of the spool 810 presses the ball of the first check valve 820 to open the first check valve 820.

That is, when the driving gear 422 rotates in the clockwise direction CW, the second check valve 840 of the pilot check valve 800 is opened to form a fluid supply path along which the fluid is supplied to the piston-side chamber 550 through the third port 410 and the first port 510. At the same time, the first check valve 820 of the pilot check valve 800 is opened to form a fluid recovery path along which the fluid contained in the rod-side chamber 620 is returned to the fluid tank through the second port 530 and the fourth port 430. At this time, since the negative pressure is generated by the gear pump 420, the fluid can be easily returned.

A piston-side hole 552 communicating with the first port 510 is provided in a side portion of the piston-side chamber 550 to form the fluid supply path.

The fluid supplied to the piston-side chamber 550 pushes the piston 720, so that the size of the piston-side chamber 550 is increased.

When the size of the piston-side chamber 550 is increased, the hollow rod 710 connected to the piston 720 is driven outward to more protrude from the outer end of the cylinder tube 600, and the size of the rod-side chamber 620 is reduced.

That is, when the piston-side chamber 550 is filled with the supplied fluid and is thus expanded due to the hydraulic pressure of the fluid, the rod-side chamber 620 is contracted, and the fluid contained in the rod-side chamber 620 is returned to the fluid tank 300. Therefore, the hollow rod 710 can be easily driven outward.

Specifically, when the piston 720 moves forward and thus the piston-side chamber 550 expands, the fluid in the rod-side chamber 620 is pressurized and is thus introduced into the hollow rod 710.

To this end, a rod-side hole 712 is formed in a side portion of the hollow rod 710. Since the rod-side hole 712 is formed in the vicinity of the piston 720, the fluid contained in the rod-side chamber 620 enters the internal space of the hollow rod 710 in a state where the hollow rod 710 is maximally driven outward.

On the other hand, the fluid introduced into the internal space 714 of the hollow rod 710 flows into the return pipe 740 from the internal space 714 of the hollow rod 710 along a fluid recovery path denoted by reference numerals (1), (2), and (3).

To this end, the return pipe 740 has an elongated hole longitudinally extending therethrough and a return pipe main hole 742 at an end thereof.

In addition, the return pipe 740 has one or more return pipe side holes 744 in the vicinity of the return pipe main hole 742. Therefore, the fluid in the internal space 714 of the hollow rod 710 can be easily introduced into the return pipe 740.

As described above, the fluid introduced into the internal space of the return pipe 740 is transferred to the fluid tank through the second port 530 of the cylinder housing 500. Since the second port 530 is configured to communicate with the fourth port 430 of the pump housing 400, the fluid is transferred to the first check valve 820 constituting the pilot check valve 800.

Next, the fluid transferred to the first check valve 820 flows forward and enters the left chamber L, and then the fluid in the left chamber L flows forward and enters the fluid tank 300 through the sixth check valve 428.

In addition, the inside of the pump housing 400 is provided with a release valve for preventing breakage of the fluid flow path attributable to overpressure during the transfer of the fluid. In the present embodiment, the electric hydraulic actuator further includes a fifth port 450 and a manual switching two-way check valve 440 to regulate the hydraulic pressure when it is necessary to manually operate the hollow rod 710 while protecting the third port 410 and the fourth port 430.

In the present embodiment, a first end of the fifth port 450 is connected to the third port 410 and a second end of the fifth port 450 is connected to the manual switching two-way check valve 440 connected to the fourth port 430. Therefore, a hydraulic pressure release function can be performed, and a relief function can be manually performed when required. Alternatively, the first end of the fifth port 450 may be connected to the fourth port 430 and the second end of the fifth port 450 may be connected to the manual switching two-way check valve 440 connected to the third port 410.

Referring to FIG. 6A, the manual switching two-way check valve 440 includes a body, a spring disposed inside the body, and a third check valve 442 and a fourth check valve 444 disposed inside the body and arranged at both sides of the spring, respectively.

The manual switching two-way check valve 440 configured as described above performs a release function in which, when a fluid pressure higher than a predetermined pressure is detected at the third port 410 or the fourth port 430 due to the elastic force of the spring, the third check valve or the fourth check valve of the two-way check valve 440 is opened so that the overpressure can be relieved.

In addition, the body of the manual switching two-way check valve 440 is coupled to the pump housing in a screwed manner. Therefore, the user can adjust the tightness of the coupling between the pump housing 400 and the body of the manual switching two-way check valve 440. By adjusting the tightness of the coupling, it is possible to relieve the hydraulic pressure applied to the third port 410 and the hydraulic pressure applied to the fourth port 430 at the same time, thereby guiding the fluid to the fluid tank 300. After the pressure of the fluid is relieved, the user can easily manually adjust the distance by which the hollow rod 710 is driven outward to be exposed outside the cylinder tube.

That is, the manual switching two-way check valve 440 performs a relief function of simultaneously relieving the hydraulic pressure applied to the third port 410 and the hydraulic pressure applied the fourth port 430 through the adjustment of the coupling with the pump housing, and a release function in which the third check valve 442 and the fourth check valve 444 exert a force on the third port 410 and the fourth port 430, respectively.

On the other hand, when the hollow rod 710 is retracted, the fluid is transferred in the opposite direction. That is, the driving gear 422 rotates in the counterclockwise direction CCW, the fifth check valve 426 is opened, a negative pressure is created in the right chamber R, and a hydraulic pressure is created in the left chamber L.

When the hydraulic pressure is created in the left chamber L, the first check valve 820 is opened by the hydraulic pressure, the spool 810 moves to the right, and the protrusion formed on at the right end of the spool 810 presses the ball of the second check valve 840 to open the second check valve 840.

When the first check valve 820 is opened, the fluid is transferred through the fourth port 430. Since the fourth port 430 is connected with the second port 530 of the cylinder housing 500, the fluid is supplied to the rod-side chamber 620 through the return pipe 740 and the hollow rod 710.

The fluid supplied to the rod-side chamber 620 pushes the piston 720 to expand the rod-side chamber 620.

When the rod-side chamber 620 is expanded, the hollow rod 710 connected with the piston 720 is retracted into the cylinder tube 600, and thus the piston-side chamber 550 is reduced.

When the piston-side chamber 550 is reduced as described above, the fluid in the piston-side chamber 550 is transported to the gear pump 420 or is returned to the fluid tank 300 through the first and third ports 510 and 410 and the second and fifth check valves 840 and 426.

What is claimed is:

1. An electric hydraulic actuator comprising:
a hydraulic cylinder including a hollow rod that is connected to a piston and is linearly movable to protrude outward or to retract when a working fluid is supplied to or discharged from a cylinder housing; and
a hydraulic power generator including a motor, a fluid tank, and a gear pump and a pilot check valve disposed in a pump housing, the hydraulic power generator converting a rotational force of the motor into a hydraulic pressure and transferring the hydraulic pressure to the hydraulic cylinder,
wherein the cylinder housing and the pump housing are directly coupled to each other,
the cylinder housing includes a first port through which the working fluid is transferred to a first side of the piston so that the hollow rod is driven outward to protrude an increased distance from a leading end of the cylinder tube and a second port connected to a return pipe that is provided in the hollow rod and through which the working fluid is discharged from the hollow rod, and
the pump housing includes a third port that is configured to communicate with the first port and through which the working fluid extracted from the fluid tank is supplied to the hydraulic cylinder due to a negative pressure generated by rotation of the motor and a fourth port that is configured to communicate with the second port and through which the working fluid discharged from the return pipe is transferred to the gear pump.

2. An electric hydraulic actuator comprising:
a motor providing a rotational force;
a pump housing provided with a gear pump that converts the rotational force of the motor to a hydraulic pressure and thus forces a fluid to move and with a pilot check valve that changes a fluid flow path using the hydraulic pressure;
a fluid tank disposed between the motor and the pump housing and providing a fluid storage space;
a coupler extending through the fluid tank and connecting a rotary shaft of the motor and the gear pump to each other;
a cylinder tube;
a hollow rod disposed in the cylinder tube and connected to a piston so that a length of a portion of the cylinder tube exposed outside the cylinder tube varies according to a fluid supply path determined by operation of the gear pump;
a cylinder housing coupled to one end of the cylinder tube and to the pump housing, the cylinder housing including two ports for transferring the fluid; and
a return pipe having a first end coupled to the cylinder housing and a second end positioned within the hollow rod, thereby forming a flow path of the fluid between an internal space of the hollow rod and an internal space of the cylinder housing,
wherein the two ports of the cylinder housing include a first port forming a flow path of the fluid supplied to a first side of the piston and a second port forming a flow path of the fluid returned to the return pipe, and
the pump housing includes a third port corresponding to the first port and functioning to transfer the fluid to the gear pump and a fourth port corresponding to the second port and functioning to transfer the fluid to the gear pump.

3. The hydraulic actuator according to claim 2, wherein two or more volume supplementary members having an air cell structure are provided in the fluid tank to fill an empty portion of the fluid tank when a fluid shortage occurs in the fluid tank when the fluid is returned to the fluid tank.

4. The hydraulic actuator according to claim 2, further comprising a guide pipe disposed between the volume supplementary member and a coupler.

5. The hydraulic actuator according to claim 2, wherein the third port and the fourth port are connected to each other via a fifth port and a manual switching two-way check valve,
the manual switching two-way check valve has a relief function of simultaneously relieving a hydraulic pressure applied to the third port and a hydraulic pressure applied to the fourth port by changing a coupling position of a body thereof, and
the manual switching two-way check valve includes a third check valve and a fourth check valve that are disposed in the body and arranged to face each other with one spring interposed therebetween, and the manual switching two-way check valve has a two-way release function in which when a fluid pressure higher than a predetermined pressure is detected at one of the third and fourth ports due to an elastic force of the spring, one of the third and fourth check valves, which is in contact with the one port of the third and fourth ports, is opened so that an overpressure is released.

6. The hydraulic actuator according to claim 2, wherein an internal space of the cylinder tube is partitioned into a piston-side chamber defined between the piston and the cylinder housing and a rod-side chamber defined between the piston and a cylinder cap covering a second end of the cylinder tube,
a rod-side hole is formed in a side portion of the hollow rod to transfer the fluid contained in the rod-side chamber into the hollow rod, and
a return pipe main hole is formed at an end of the return pipe to form an inflow path extending from the rod-side hole to an internal space of the hollow rod.

7. The hydraulic actuator according to claim 6, wherein at least one return pipe-side hole is formed in a side portion of the return pipe in the vicinity of the return pipe main hole.

8. The hydraulic actuator according to claim 6, wherein the rod-side hole is formed in the vicinity of the piston.
